(19) United States
(12) Patent Application Publication
(10) Pub. No.: US 2004/0192801 A1
(43) Pub. Date: Sep. 30, 2004

(54) Method for the production of polyurethane soft foam materials

(76) Inventors: Stephan Bauer, Ostercappeln (DE); Kathrin Harre, Dresden (DE); Raimund Ruppel, Dresden (DE); Edward Bohres, Ludwigshafen (DE)

Correspondence Address: BASF CORPORATION, LEGAL DEPARTMENT, 1609 BIDDLE AVENUE, WYANDOTTE, MI, 48192, US

(21) Appl. No.: 10/484,600

(22) PCT Filed: Jul. 16, 2002
(86) PCT No.: PCT/EP02/07887

(30) Foreign Application Priority Data
Aug. 3, 2001 (DE) 10137628.6

(51) Int. Cl. C08G 18/00

(52) U.S. Cl. 521/174

(57) ABSTRACT

Flexible polyurethane foams are prepared by reacting

a) polyisocyanates with

b) compounds having at least two hydrogen atoms reactive with isocyanate groups, in the presence of

c) blowing agents,

by a process in which at least one polyether alcohol which can be prepared by reacting alkylene oxides with H-functional initiator substances in the presence of DMC catalysts, having a content of DMC catalysts of from 0.1 to 1 000 ppm, based on the weight of the polyether alcohol, are used as compounds b) having at least two hydrogen atoms reactive with isocyanate groups.

The present invention relates to a process for the preparation of flexible polyurethane foams by reacting polyisocyanates with polyether alcohols.

The preparation of polyurethanes has long been known and is widely described. It is usually carried out by reacting polyisocyanates with compounds having at least two hydrogen atoms reactive with isocyanate groups. In general polyols, in particular polyether alcohols and/or polyester alcohols, are used as compounds having two hydrogen atoms reactive with isocyanate groups.

The polyether alcohols are usually prepared by a catalytic addition reaction of lower alkylene oxides, generally ethylene oxide and/or propylene oxide, with H-functional initiator substances. In general, potassium hydroxide solution is used as the catalyst in the industrial production of polyether alcohols. In the preparation of high molecular weight polyether alcohols, as required in particular for use for flexible polyurethane foams, the use of potassium hydroxide solution as a catalyst results in secondary reactions which lead to the formation of the unsaturated components in the polyether alcohol. These unsaturated components in the polyether alcohol are undesired since they reduce the functionality of the polyether alcohols and also lead to odor problems of the polyether alcohols.

For eliminating this deficiency, the use of alternative catalysts for the addition reaction of the alkylene oxides has been proposed. A frequently described catalyst type comprises multimetal cyanide catalysts, frequently also referred to as DMC catalysts. Such catalysts are described, for example, in EP 862 947 or WO 99/16775. With the use of such catalysts, the formation of the unsaturated components is greatly suppressed.

The difficulty with the use of DMC catalysts is their separation from the prepared polyether alcohol after the reaction. One possibility for the separation is to deactivate the catalyst chemically and then separate it from the polyether alcohol. Since the multimetal cyanide catalysts are generally present in very finely divided form in the polyether alcohol, the separation is very difficult.

U.S. Pat. No. 5,416,241 describes a process for the preparation of polyether alcohols by means of DMC catalysts. After the reaction, the catalyst is rendered insoluble by adding alkali metal compounds and is then filtered. In the process described in U.S. Pat. No. 5,248,833, the DMC catalyst is precipitated with a chelating agent and then filtered.

EP 759 450 (U.S. Pat. No. 5,811,829) describes polyether alcohols prepared by means of DMC catalysts and prepolymers prepared from said polyether alcohols and containing from 10 to 1 000 ppm of double metal cyanides. These compounds are said to have a better shelf-life than those without this content of multimetal cyanides. The use of these polyether alcohols and prepolymers for the preparation of flexible polyurethane foams is not described.

In Volume 7, Polyurethane, Carl-Hanser-Verlag, Munich, Vienna, 3rd Edition 1993, page 204, it is stated that impurities in the raw materials, for example nonferrous metals and oxidizing agents, lead to core discolorations in the flexible polyurethane foam prepared therefrom.

The core discoloration is observed in particular at low densities of less than 40, in particular of 30, kg/m³, owing to the increasing temperature during the preparation of flexible polyurethane foams, especially of flexible slabstock foams. In the most unfavorable case, burning of the flexible foams may occur.

The nonferrous metals include, for example, cadmium, cobalt, copper, nickel, lead, tin and zinc. These metals and their soluble compounds are generally highly toxic for the human body.

When using polyether alcohols prepared by means of DMC catalysts, it is therefore necessary that no heavy metals emerge from the foams. This applies in particular with the use of the polyether alcohols for the preparation of flexible polyurethane foams. Since the flexible polyurethane foams are frequently used in mattresses and reclining furniture, there should be no exposure at all to heavy metals from the foam even under the action of moisture, as formed, for example, by perspiration.

It is an object of the present invention to provide a process for the preparation of flexible polyurethane foams by reacting polyisocyanates with polyether alcohols which were prepared by means of multimetal cyanide catalysts, in which process no core discolorations occur and which process leads to foams from which no heavy metal ions can emerge.

We have found that this object is achieved and that, surprisingly, polyether alcohols which were prepared by means of multimetal cyanide catalysts can be used for the preparation of flexible polyurethane foams without core discolorations or other decomposition reactions occurring, if they contain from 0.1 to 1 000, in particular from 1 to 500, preferably from 10 to 200, ppm, based on the weight of the polyether alcohol, of multimetal cyanide compounds.

When the zinc hexacyanocobaltates usually used are employed, this corresponds to a cobalt content of from 0.008 to 80 ppm, preferably from 0.8 to 40 ppm, in particular from 1.6 to 16 ppm, and a zinc content of from 0.02 to 200 ppm, preferably from 2 to 100 ppm, in particular from 4 to 40 ppm, based on the general-purpose flexible polyether/polyurethane foam having a density of about 30 kg/m³.

The present invention relates to a process for the preparation of flexible polyurethane foams by reacting

a) polyisocyanates with

b) compounds having at least two hydrogen atoms reactive with isocyanate groups, in the presence of

c) blowing agents,

wherein at least one polyether alcohol which can be prepared by reacting alkylene oxides with H-functional initiator substances in the presence of DMC catalysts, having a content of DMC catalysts of from 0.1 to 1 000 ppm, based on the weight of the polyether alcohol, is used as compounds b) having at least two hydrogen atoms reactive with isocyanate groups.

The present invention furthermore relates to flexible polyurethane foams without core discoloration, which can be prepared by the novel process.

The present invention furthermore relates to flexible polyurethane foams which contain extractable heavy metals below the limits of the Öko-Tex Standard 100 according to product classes 2 to 4 of:

| | |
|---|---|
| Lead (Pb) | 1.0 ppm |
| Cadmium (Cd) 1 | 0.1 ppm |
| Chromium (Cr) | 2.0 ppm |
| Cobalt (Co) | 4.0 ppm |
| Copper (Cu) | 50.0 ppm |
| Nickel (Ni) | 4.0 ppm |
| Mercury (Hg) | 0.02 ppm |

and in particular flexible polyurethane foams which contain extractable heavy metals below the limits of Öko-Tex Standard 100 according to product class 1 of:

| | |
|---|---|
| Lead (Pb) | 0.2 ppm |
| Cadmium (Cd)1 | 0.1 ppm |
| Chromium (Cr) | 1.0 ppm |
| Cobalt (Co) | 1.0 ppm |
| Copper (Cu) | 25.0 ppm |
| Nickel (Ni) | 1.0 ppm |
| Mercury (Hg) | 0.02 ppm |

The extraction is carried out with a foam body having the dimensions 100×50 mm using simulated perspiration, according to DIN 53160-2. The simulated perspiration has a pH of 6.5±0.1.

The composition of the simulated perspiration is as follows:

| | |
|---|---|
| Sodium chloride | 5.0 g/l |
| Urea | 1.0 g/l |
| Lactic acid (>88% by mass) | 1.0 g/l |

Ammonium hydroxide solution (1% by mass) added to pH=6.5±0.1

In order to determine the extractable heavy metals, the foam body is stored in about 500 ml of simulated perspiration in a migration cell having a cover for 24 hours at 40° C. After storage, the foam body is separated from the migration solution, the migration solution in the foam having been removed by dripping off. The quantitative determination is carried out in an atomic desorption spectrometer or by inductively coupled plasma (ICP).

The present invention furthermore relates to the use of the flexible polyurethane foams prepared by the novel process for the production of mattresses and furniture.

Surprisingly, the multimetal cyanide compounds have no adverse effect at all on the urethane formation reaction.

The polyether alcohols used for the novel process and containing from 0.1 to 1 000 ppm of multimetal cyanide compounds are prepared, as described above, by a catalytic addition reaction of alkylene oxides with H-functional initiator substances, the catalysts used being multimetal cyanide compounds.

The multimetal cyanide compounds used for the preparation of the polyether alcohols employed according to the invention are known. They are generally of the formula (I)

M¹ₐ[M²(CN)_{b}(A)_{c}]_{d}.fM¹gXₙ.h(H₂O).eL (I)

where

M¹ is a metal ion selected from the group consisting of Zn2+, Fe2+, Co3+, Ni2+, Mn2+, Co2+, Sn2+, Pb2+, Mo4+, Mo6+, Al3+, V4+, V5+, Sr2+, W4+, W6+, Cr2+, Cr3+, Cd2+, Hg2+, Pd2+, Pt2+, V2+, Mg2+, Ca2+, Ba2+, Cu2+,

M² is a metal ion selected from the group consisting of Fe2+, Fe3+, Co2+, Co3+, Mn2+, Mn3+, V4+, V5+, Cr2+, Cr3+, Rh3+, Ru2+, Ir3+

and M¹ and M² are identical or different,

A is an anion selected from the group consisting of halide, hydroxide, sulfate, carbonate, cyanide, thiocyanate, isocyanate, cyanate, carboxylate, oxalate and nitrate, and

X is an anion selected from the group consisting of halide, hydroxide, sulfate, carbonate, cyanide, thiocyanate, isocyanate, cyanate, carboxylate, oxalate and nitrate,

L is a water-miscible ligand selected from the group consisting of alcohols, aldehydes, ketones, ethers, polyethers, esters, ureas, amides, nitriles, lactones, lactams and sulfides,

and

a, b, c, d, g and n are selected so that the electroneutrality of the compound is ensured, and

e is the coordination number of the ligand or 0,

f is a fraction or integer greater than or equal to 0 and

h is a fraction or integer greater than or equal to 0.

These compounds are prepared by generally known processes, by combining the aqueous solution of a water-soluble metal salt with the aqueous solution of a hexacyanometallate compound, in particular of a salt or of an acid, also referred to below as starting material solutions, and, if required, adding a water-soluble ligand to the mixture during or after the combination. Such catalysts and their preparation are described, for example, in EP 862 947 and DE 19 742 978.

Multimetal cyanide compounds prepared using the corresponding acids as cyanometallate compounds are particularly advantageous for use as catalysts.

The multimetal cyanide compounds preferably have a crystalline structure. Their particle size is preferably from 0.1 to 100 μm. A particular advantage of the crystalline DMC catalysts, in particular of those which were prepared using cyanometallate acids, is their higher catalytic activity. Consequently, the preparation of the polyether alcohols can be carried out using a smaller amount of catalyst. The amount used in this case generally corresponds to the novel amount of multimetal cyanide compounds in the prepared polyether alcohol. The expensive separation of the multimetal cyanide compounds from the polyether alcohol after the preparation can thus be dispensed with. However, it is also possible to use a larger amount of multimetal cyanide compounds and, after the synthesis of the polyether alcohol, to reduce the amount of multimetal cyanide compound in the polyether alcohol to such an extent that the polyether alcohol contains the amount of multimetal cyanide compounds which are necessary for the novel process.

The multimetal cyanide compounds are preferably used in the form of suspensions, the multimetal cyanide compounds being suspended in organic compounds, preferably alcohols.

The polyether alcohols used for the novel process are prepared, as stated, by subjecting alkylene oxides to an addition reaction with H-functional initiator substances with the use of the catalysts described.

Alkylene oxides which may be used are all known alkylene oxides, for example ethylene oxide, propylene oxide or butylene oxide, and styrene oxide; alkylene oxides used in particular are ethylene oxide, propylene oxide and mixtures of said compounds.

Initiator substances used are H-functional compounds. In particular, alcohols having a functionality of from 1 to 8, preferably from 2 to 8, are used. For the preparation of polyether alcohols which are used for flexible polyurethane foams, in particular alcohols having a functionality of from 2 to 4, in particular of 2 or 3, are used as initiator substances. Examples are ethylene glycol, propylene glycol, glycerol, trimethylolpropane and pentaerythritol. In the addition reaction of the alkylene oxides by means of DMC catalysts, it is advantageous, together with or instead of said alcohols, to use their reaction products with alkylene oxides, in particular propylene oxide. Such compounds preferably have a molar mass of up to 500 g/mol. The addition reaction of alkylene oxides in the preparation of these reaction products can be carried out using any desired catalysts, for example using basic catalysts. Polyether alcohols for the preparation of flexible polyurethane foams generally have a hydroxyl number of from 20 to 100 mg KOH/g.

The addition reaction of the alkylene oxides in the preparation of the polyether alcohols used for the novel process can be carried out by the known processes. Thus, it is possible for the polyether alcohols to contain only one alkylene oxide. With the use of a plurality of alkylene oxides, a blockwise addition reaction in which the alkylene oxides undergo addition individually in succession or a random addition reaction in which the alkylene oxides are metered in together is possible. It is also possible to incorporate both blockwise and random segments into the polyether chain during the preparation of the polyether alcohols.

Polyether alcohols having a high content of secondary hydroxyl groups and a content of not more than 30% by weight, based on the weight of the polyether alcohol, of ethylene oxide units in the polyether chain are preferably used for the preparation of flexible polyurethane slabstock foams. These polyether alcohols preferably have a propylene oxide block at the chain end. For the preparation of molded flexible polyurethane foams, in particular polyether alcohols having a high content of primary hydroxyl groups and an ethylene oxide terminal block in an amount of <20% by weight, based on the weight of the polyether alcohol, are used.

The addition reaction of the alkylene oxides is carried out under the customary conditions, at from 60 to 180° C., preferably from 90 to 140° C., in particular from 100 to 130° C., and from 0 to 20, preferably from 0 to 10, in particular from 0 to 5, bar. The mixture of initiator substance and DMC catalyst can be pretreated before the beginning of the alkoxylation, according to WO 98/52689, by stripping.

After the end of the addition-reaction of the alkylene oxides, the polyether alcohol is worked up by conventional methods, by removing the unconverted alkylene oxides and readily volatile components, usually by distillation, steam or gas stripping or other deodorization methods. If required, filtration may also be carried out.

The content, according to the invention, of DMC catalyst in the polyether alcohol can, as stated, be established by various possible procedures. Thus, it is possible for the amount of DMC catalyst which corresponds to the novel content of this compound in the end product to be used before the beginning of the reaction. When a larger amount of DMC catalyst is used in the preparation of the polyether alcohols, the excess amount can be removed from the polyether alcohol after the reaction. The conventional and known methods for purifying the polyether alcohols are suitable for this purpose, for example filtration, which can be carried out as deep-bed filtration or by means of a membrane, or sedimentation, for example by means of centrifuging.

As described, the polyether alcohols thus prepared are preferably used as starting materials for the novel process for the preparation of flexible polyurethane foams.

Regarding the other starting materials used for the novel process, the following may be stated specifically.

Polyisocyanates used here are all isocyanates having two or more isocyanate groups in the molecule. Both aliphatic isocyanates, such as hexamethylene diisocyanate (HDI) or isophorone diisocyanate (IPDI), and preferably aromatic isocyanates, such as tolylene diisocyanate (TDI), diphenylmethane diisocyanate (MDI) or mixtures of diphenylmethane diisocyanate and polymethylenepolyphenylene polyisocyantes (crude MDI), may be used. It is also possible to use isocyanates which are modified by incorporation of urethane, uretdione, isocyanurate, allophanate, uretonimine and other groups, i.e. modified isocyanates.

In particular, TDI is used for the preparation of flexible slabstock foams while MDI and its higher homologs are preferably used for the preparation of molded foams.

Polyols can preferably be used as compounds having at least two groups reactive with isocyanate groups, which compounds are used as a mixture with the novel polyether alcohols. Among the polyols, the polyether polyols and the polyester polyols are of the greatest industrial importance. The polyether polyols used for the preparation of polyurethanes are generally prepared by a base-catalyzed addition reaction of alkylene oxides, in particular ethylene oxide and/or propylene oxide, with H-functional initiator substances. Polyester polyols are generally prepared by esterification of polyfunctional carboxylic acids with polyfunctional alcohols.

The compounds having at least two groups reactive with isocyanate groups also include the chain extenders and/or crosslinking agents, which, if required, may be concomitantly used. These are at least difunctional amines and/or alcohols having molecular weights of from 60 to 400.

Blowing agents used are in general water, compounds which are gaseous at the temperature of the urethane reaction and inert to the starting materials of the polyurethanes, i.e. physical blowing agents, and mixtures thereof. Physical blowing agents used are generally hydrocarbons of 2 to 6 carbon atoms, halogenated hydrocarbons of 2 to 6 carbon atoms, ketones, acetals, ethers and inert gases, such as carbon dioxide or noble gases.

Preferably used catalysts are amine compounds and/or metal compounds, in particular heavy metal salts and/or organometallic compounds. In particular, known tertiary amines and/or organic metal compounds are used as catalysts. Suitable organic metal compounds are, for example, tin compounds, such as tin(II) salts of organic carboxylic acids, e.g. tin(II) acetate, tin(II) octanoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate. Examples of organic amines customary for this purpose are triethylamine, 1,4-diazabicyclo[2,2,2]octane, tributylamine, dimethylbenzylamine, N,N,N′,N′-tetramethyl-ethylenediamine, N,N,N′,N′-tetramethylbutanediamine, N,N,N′,N′-tetramethylhexane 1,6-diamine and dimethylcyclo-hexylamine. The catalysts described can be used individually or in the form of mixtures.

For the novel process, it is preferable to use organic metal compounds as catalysts since these are very compatible with the multimetal cyanide compounds.

Assistants and/or additives used are, for example, mold release agents, flameproofing agents, dyes, fillers and/or reinforcing materials.

In industry, it is usual to mix all feedstocks with the exception of the polyisocyanates to give a polyol component and to react this with the polyisocyanates to give the polyurethane.

The preparation of the polyurethane can be carried out by the one-shot process or by the prepolymer process. The flexible polyurethane foam may be both slabstock foams and molded foam.

An overview of the feedstocks for the preparation of polyurethanes and the processes used for this purposes is to be found, for example, in Kunststoffhandbuch, Volume 7 Polyurethane, Carl-Hanser-Verlag, Munich, Vienna, 1st Edition 1966, 2nd Edition 1983 and 3rd Edition 1993.

The novel process for the preparation of flexible polyurethane slabstock foams can be particularly advantageously used since core discolorations, including burning of the core, can occur to a high degree during the foaming of large blocks.

Surprisingly, the flexible foams prepared in the presence of multimetal cyanide compounds in the amount according to the invention in the polyether alcohols also have substantially improved curing behavior, without tearing, compared with those which have a lower or higher content of multimetal cyanide compounds. No core discoloration at all occurred. This was not foreseeable by a person skilled in the art since it is generally known that heavy metals increase the tendency to tearing.

Surprisingly, the flexible polyurethane foams prepared by the novel process exhibit extremely little or no exposure of heavy metals, also under the action of moisture. Particularly with the use of crystalline multimetal cyanide compounds as catalysts in the preparation of polyether alcohols used, the metals are effectively fixed in the foam matrix.

The novel polyether alcohols can be processed to give flexible polyurethane foams having a high open cell content or high air permeability and a defect-free foam structure without tearing and without burning of the core.

Because of their very low exposure of heavy metals, they are particularly suitable for use in mattresses and furniture.

The examples which follow illustrate the invention.

### EXAMPLE 1

### Preparation of DMC Flexible Slabstock Foam

The starting materials stated in table 1 were reacted in the ratios mentioned.

All components except for the isocyanate Lupranat® T80 A were first combined with thorough mixing to give a polyol component. The Lupranat® T80 A was then added with stirring and the reaction mixture was poured into an open mold in which it foamed to give the polyurethane foam.

TABLE 1

| | | | |
|---|---|---|---|
| Polyetherpolyol | [% by wt.] | 100.00 | 100.00 |
| Water | [% by wt.] | 2.85 | 2.60 |
| Dabco ® 33LV | [% by wt.] | 0.05 | 0.05 |
| Niax ® Al | [% by wt.] | 0.05 | 0.03 |
| Dimethylethanolamine | [% by wt.] | 0.10 | 0.10 |
| Kosmos ® 29 | [% by wt.] | 0.215 | 0.21 |
| Tegostab ® 8036 | [% by wt.] | 1.00 | 1.00 |
| Lupranat ® T 80 - Index | | 108 | 108 |
| Amount of Lupranat ® T 80 | [% by wt.] | 37.33 | 35.16 |
| Processibility | | good | good |
| (Yield/Rise profile/Cell structure/ | | | |
| Tears/Shrinkage/Compaction/ | | | |
| Block form/Open cell content) | | | |
| Core discoloration | | none | none |
| Density top | [kg/m³] | 30.8 | 33.7 |
| middle | [kg/m³] | 32.2 | 34.8 |
| bottom | [kg/m³] | 32.5 | 34.9 |
| Indentation hardness 40% top | [N] | 164 | 167 |
| middle | [N] | 173 | 187 |
| bottom | [N] | 162 | 174 |
| Compressive strength 40% top | [kPa] | 3.9 | 4.1 |
| middle | [kPa] | 4.1 | 4.4 |
| bottom | [kPa] | 3.8 | 4.1 |
| Air resistance, middle | [1/min] | 125 | 112 |
| Resilience | [%] | 57 | 59 |
| Tensile strength | [kPa] | 131 | 117 |
| Elongation | [%] | 181 | 158 |

### EXAMPLE 2

### Determination of the Migration of Cobalt from the Foam, According to Example 1

| | |
|---|---|
| Samples: | Foam cube measuring 100 × 100 × 50 mm |
| Simulated/ | Simulated perspiration according to DIN |
| Test migration agent: | 53160 |
| Migration conditions: | 24 h at 40° C.; the two test specimens are |
| | each stored in about 500 ml of simulated |
| | perspiration in a migration cell with a |
| | cover. |
| Method of determination: | After storage and cooling to |
| | room temperature, test specimens and |
| | migration solution were separated, the |
| | migration solution in the foam bodies |
| | being removed by dripping off. In the |
| | migration agent, cobalt was determined by |
| | atomic spectroscopy. |
| Limit of quantitation: | w(Co) about 0.01 mg/l |
| Results: | The results of the investigation are |
| | listed in the table below. The data are |
| | expressed in μg/kg assuming that 1 kg of |
| | test migration agent is in contact with |
| | 6 dm²: |

TABLE 2

| | |
|---|---|
| Simulated/ | Migration |

| Analysis | Test migration agent: | μg/dm² | μg/kg |
|---|---|---|---|
| Cobalt | Simulated perspiration | <1.2 | <7 |

The maximum amount of extractable cobalt (CO)_{Migration} can be derived from the cobalt content determined (limit of quantitation), the weight of the test migration agent sample and the weight of the test specimens. Under the stated test conditions, the value w(CO)_{Migration} is <0.3 μg/kg.

1. A process for the preparation of flexible polyurethane foams comprising reacting
a) polyisocyanates with
b) compounds having at least two hydrogen atoms reactive with isocyanate groups, in the presence of
c) blowing agents,
wherein at least one polyether alcohol, which is prepared by reacting alkylene oxides with H-functional initiator substances in the presence of DMC catalysts, having a content of DMC catalysts of from 0.1 to 1 000 ppm, based on the weight of the polyether alcohol, is used as compounds b) having at least two hydrogen atoms reactive with isocyanate groups.

2. A process as claimed in claim 1, wherein the compounds having at least two hydrogen atoms reactive with isocyanate groups contain from 1 to 500 ppm of multimetal cyanide compounds.

3. A process as claimed in either of claims 1 or 2, wherein the multimetal cyanide compound is of the formula (I)
M¹ₐ[M²(CN)_{b}(A)_{c}]_{d}.fM¹gXₙ.h(H₂O).eL (I)
where
M¹ is a metal ion selected from the group consisting of Zn2+, Fe2+, Co3+, Ni2+, Mn2+, Co2+, Sn2+, Pb2+, Mo4+, Mo6+, A13+, V4+, V5+, Sr2+, W4+, W6+, Cr2+, Cr3+, Cd2+, Hg2+, Pd2+, Pt2+, V2+, Mg2+, Ca2+, Ba2+, Cu2+,
M² a metal ion selected from the group consisting of Fe2+, Fe3+, Co2+, Co3+, Mn2+, Mn3+, V4+, V5+, Cr2+, Cr3+, Rh3+, Ru2+, Ir3+
and M¹ and M² are identical or different,
A is an anion selected from the group consisting of halide, hydroxide, sulfate, carbonate, cyanide, thiocyanate, isocyanate, cyanate, carboxylate, oxalate and nitrate,
X is an anion selected from the group consisting of halide, hydroxide, sulfate, carbonate, cyanide, thiocyanate, isocyanate, cyanate, carboxylate, oxalate and nitrate,
L is a water-miscible ligand selected from the group consisting of alcohols, aldehydes, ketones, ethers, polyethers, esters, ureas, amides, nitrites, lactones, lactams and sulfides,
and
a, b, c, d, g and n are selected so that the electroneutrality of the compound is ensured, and
e is the coordination number of the ligand or 0,
f is a fraction or integer greater than or equal to 0 and
h is a fraction or integer greater than or equal to 0.

4. A process as claimed in claim 3, wherein, in the formula, M¹ is zinc and M² is cobalt.

5. A process as claimed in claim 3, wherein the multimetal cyanide compound is crystalline.

6. A process as claimed in claim 1, wherein the blowing agent used is water.

7. A process as claimed in claim 1, wherein the reaction of the polyisocyanate a) with the compounds b) having at least two hydrogen atoms reactive with isocyanate groups is carried out in the presence of catalysts.

8. A process as claimed in claim 7, wherein the catalysts used are tin compounds and/or amines.

9. A process as claimed in claim 1, wherein the flexible polyurethane foam is a flexible slabstock foam.

10. A flexible polyurethane foam without burning of the core, which is prepared in accordance with the process as claimed in any one of claims 1 to 6.

11. A flexible polyurethane foam which is prepared in accordance with the process as claimed in any one of claims 1 to 6, wherein the flexible polyurethane foam contains extractable heavy metals below the limits of the Öko-Tex Standard 100 according to product classes 2 to 4 of:

| | |
|---|---|
| Lead (Pb) | 1.0 ppm |
| Cadmium (Cd)1 | 0.1 ppm |
| Chromium (Cr) | 2.0 ppm |
| Cobalt (Co) | 4.0 ppm |
| Copper (Cu) | 50.0 ppm |
| Nickel (Ni) | 4.0 ppm |
| Mercury (Hg) | 0.02 ppm |

12. A flexible polyurethane foam as claimed in claim 11 for the production of mattresses and furniture.

13. A process as claimed in claim 4, wherein the multimetal cyanide compound is crystalline.
